(19) United States
(12) Patent Application Publication
(10) Pub. No.: US 2016/0356493 A1
(43) Pub. Date: Dec. 8, 2016

(54) LINEARLY-ADJUSTABLE VALVE BODY

(71) Applicant: Qibiao XIE, Zhongshan City (CN)

(72) Inventor: Qibiao XIE, Zhongshan City (CN)

(21) Appl. No.: 14/844,720

(22) Filed: Sep. 3, 2015

(30) Foreign Application Priority Data
Jun. 8, 2015 (CN) 201520390233.7

(51) Int. Cl. F23N 1/00; F16K 31/60; F16K 5/02; F16K 31/04

(52) U.S. Cl. CPC F23N 1/002; F16K 31/041; F16K 31/60; F16K 5/0207; F23N 2035/24

(57) ABSTRACT

Disclosed is a linearly-adjustable valve body, which comprises a valve seat and a valve core, wherein the inside of the valve seat is provided with a mounting hole for housing the valve core. One end of the valve core is inserted into the mounting hole and can rotate relative to the mounting hole. The two sides of the valve seat are also respectively provided with an air inlet hole and at least one air outlet hole, both the air inlet hole and the air outlet hole are communicated with the mounting hole. The inside of the valve core is provided with a channel communicated with the air inlet hole. The outer side wall of the valve core is provided with at least one first through hole set communicated with the channel or at least one recess having a gradient cross sectional area.

### CROSS REFERENCE TO RELATED APPLICATIONS

The present application claims priority under 35 USC 119 to Chinese Patent Application No. 201520390233.7, filed Jun. 8, 2015, the contents of which are incorporated herein by reference.

### FIELD OF THE INVENTION

The invention relates to a linearly-adjustable valve body.

### BACKGROUND

The firepower of a stove or other gas burner needs to be adjusted frequently. The present adjusting method generally is implemented to control the firepower through adjusting the air inlet quantity via a gas valve body. However, the current gas valve body is complicated in structure, and has high manufacturing cost, which decreases the enterprise competitiveness. Therefore, the invention provides a linearly-adjustable valve body with a simple structure for solving the foregoing problems.

### SUMMARY

In order to solve the foregoing problems, the invention provides a linearly-adjustable valve body.

To solve the technical problem, the invention employs a technical solution as follows.

A linearly-adjustable valve body comprises a valve seat and a valve core, wherein the inside of the valve seat is provided with a mounting hole for housing the valve core, one end of the valve core is inserted into the mounting hole and can rotate relatively to the mounting hole, the two sides of the valve seat are also respectively provided with an air inlet hole and at least one air outlet hole, both the air inlet hole and the air outlet hole are communicated with the mounting hole, the inside of the valve core is provided with a channel communicated with the air inlet hole, the outer side wall of the valve core is provided with at least one first through hole set communicated with the channel or at least one recess having a gradient cross sectional area, the first through hole set comprises a plurality of first through holes which are annularly distributed along the outer side wall of the valve core and have gradient diameters, the recess is distributed annularly along the outer side wall of the valve core, one end of the recess is communicated with the channel through a second through hole, and the position of the air outlet hole is corresponding to the first through hole set or the recess.

The width of the recess is gradual.

The mounting hole is in a round table shape, and the end portion of the valve core inserted into the mounting hole is also in a round table shape.

The number of the air outlet hole is two, and the number of the corresponding first through hole set and the number of the corresponding recess are respectively two.

The other end of the valve core is connected to a knob.

The other end of the valve core is connected to a drive motor.

The linearly-adjustable valve body further comprises a self-power generating device, wherein the self-power generating device is connected to the drive motor.

The self-power generating device is a thermoelectric power generating device.

The invention has the advantageous effects that: the invention employing the foregoing structure adjusts the overlapped area between the air outlet hole and the first through hole set or the recess to control the air inlet quantity through rotating the valve core, thus being capable of realizing continuous and linear adjusting. The invention also has the advantages of simple structure, convenient manufacture, low cost, stable operation and high economic benefit.

### BRIEF DESCRIPTION OF THE DRAWINGS

The invention will be further described in details hereinafter with reference to the drawings and embodiments.

FIG. 1 is a schematic view of the invention;

FIG. 2 is a first exploded schematic view of the invention;

FIG. 3 is a second exploded schematic view of the invention;

FIG. 4 shows the first embodiment of the valve core according to the invention:

FIG. 5 shows the second embodiment of the valve core according to the invention;

FIG. 6 shows the third embodiment of the valve core according to the invention; and

FIG. 7 is a schematic view of the invention driven through a knob.

### DETAILED DESCRIPTION OF THE EMBODIMENTS

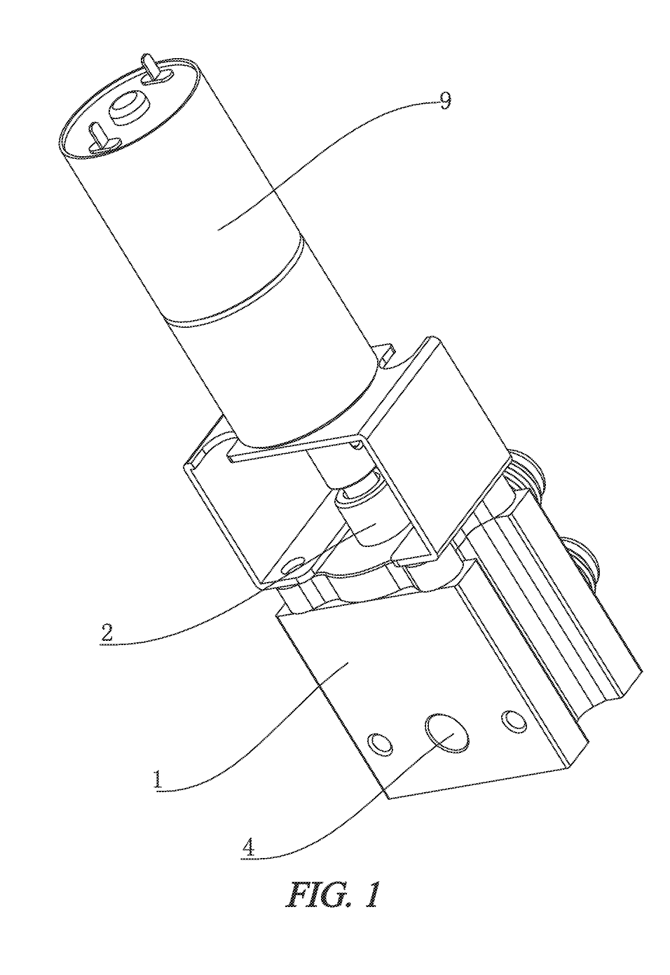

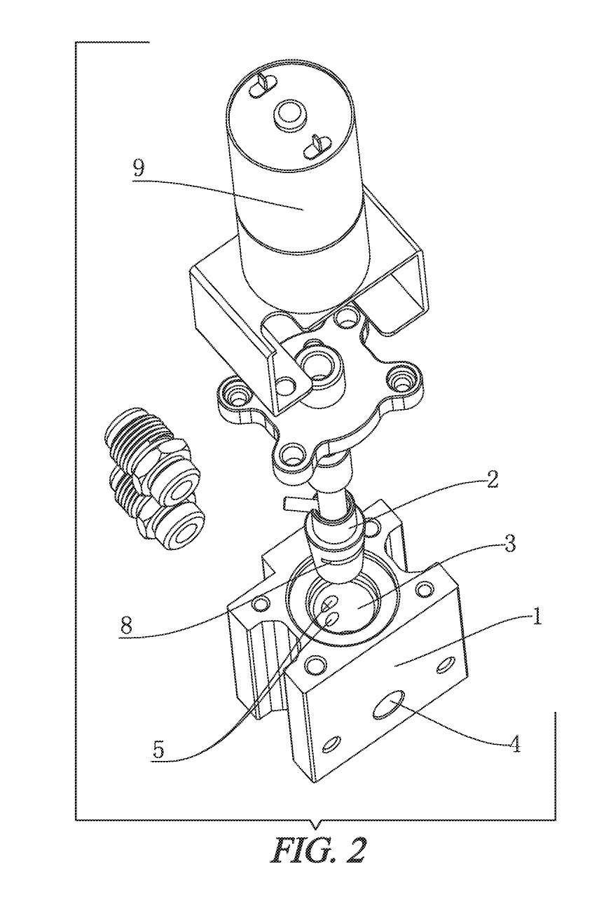

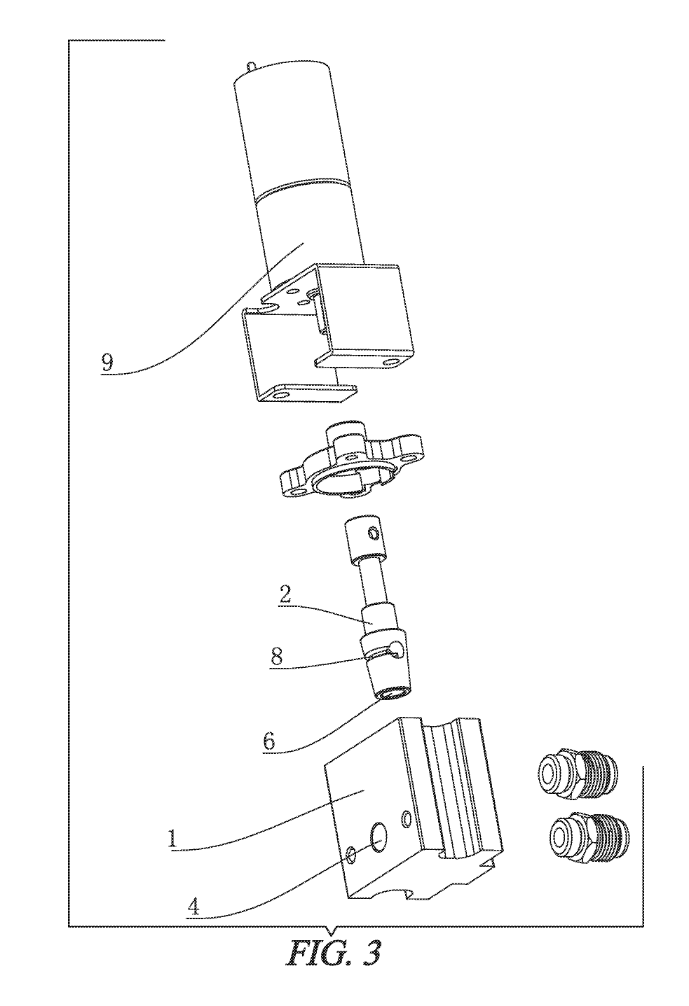

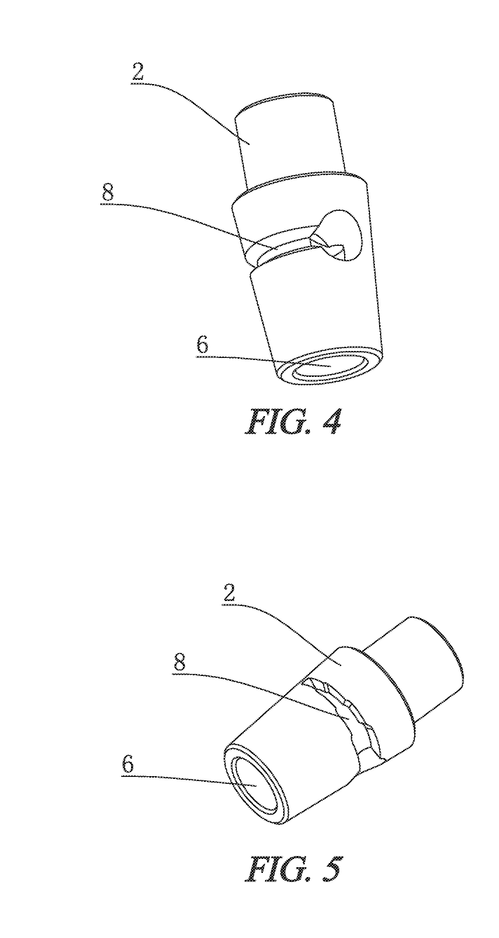

Referring to FIGS. 1 to 7, the invention provides a linearly-adjustable valve body, which comprises a valve seat 1 and a valve core 2. The inside of the valve seat 1 is provided with a mounting hole 3 for housing the valve core 2. One end of the valve core 2 is inserted into the mounting hole 3 and can rotate relatively to the mounting hole 3. The two sides of the valve seat 1 are also respectively provided with an air inlet hole 4 and at least one air outlet hole 5 (the number of the air outlet hole 5 can be configured according to the number of pipelines controlled by the air outlet hole), and both the air inlet hole 4 and the air outlet hole 5 are communicated with the mounting hole 3. The inside of the valve core 2 is provided with a channel 6 communicated with the air inlet hole 4, the outer side wall of the valve core 2 is provided with two first through hole sets that are communicated with the channel 6 or two recesses 8 that have a gradient cross sectional area. The first through hole set comprises a plurality of first through holes 7 which are annularly distributed along the outer side wall of the valve core 2 and have gradient diameters. The recess 8 is distributed annularly along the outer side wall of the valve core 2, wherein one end of the recess 8 is communicated with the channel 6 through a second through hole. The position of the air outlet hole 5 corresponds to the first through hole set or the recess 8, and the diameter of the air outlet hole 5 is greater than the spacing between two adjacent first through holes 7. The mounting hole 3 is in a round table shape, and the end portion of the valve core 2 inserted into the mounting hole 3 is also in a round table shape, wherein the design of the round table shape enables the valve core 2 to be connected to the valve seat 1 more tightly. According to the invention, the overlapped area between the air outlet hole 5 and the first through hole set or the recess 8 is adjusted through rotating the valve core 2 so as to control the air inlet quantity, thus being capable of realizing continuous and linear adjusting. The invention has the advantages of simple structure, convenient manufacture, low cost, stable operation and high economic benefit.

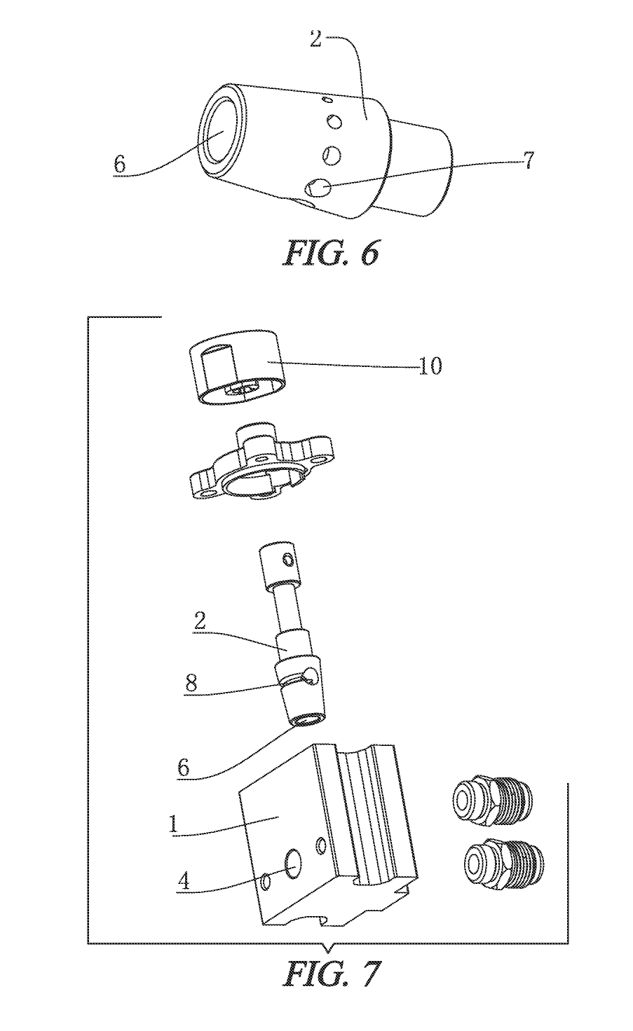

Referring to the valve core 2 as shown in FIGS. 1-4, the width and the depth of the recess 8 are gradual, thus achieving the effect of adjusting the cross section to be gradual. FIG. 5 shows the second embodiment of the valve core 2. FIG. 6 shows the third embodiment of the valve core 2, wherein the depth of the recess 8 is gradual.

As shown in FIG. 7, the other end of the valve core 2 is connected to a knob 10 so as to drive the valve core 2 manually, or drive the valve core through a motor (with high degree of automation). In the case of the valve core driven through a motor, the other end of the valve core 2 is connected to a drive motor 9 which can drive the valve core through an external power supply or a built-in self-power generating device, such as a thermoelectric power generating device.

The foregoing embodiments are merely preferred schemes of the invention, and the invention may also have other implementation schemes. Those skilled in the art may make equivalent modification or replacement without departing from the spirit of the invention, and these equivalent modifications or replacements shall all fall within the scope of the claims of the present application.

What is claimed is:

1. A linearly-adjustable valve body comprising:
a valve seat, and
a valve core,
wherein:
the inside of the valve seat is provided with a mounting hole for housing the valve core, one end of the valve core is inserted into the mounting hole and can rotate relatively to the mounting hole;
two sides of the valve seat are respectively provided with an air inlet hole and at least one air outlet hole, both the air inlet hole and the air outlet hole are communicated with the mounting hole;
the inside of the valve core is provided with a channel communicated with the air inlet hole;
the outer side wall of the valve core is provided with at least one first through hole set communicated with the channel or at least one recess having a gradient cross sectional area,
wherein the first through hole set comprises a plurality of first through holes which are annularly distributed along the outer side wall of the valve core and have gradual diameters, the recess is distributed annularly along the outer side wall of the valve core, one end of the recess is communicated with the channel through a second through hole, and the position of the air outlet hole corresponds to the first through hole set or the recess.

2. The linearly-adjustable valve body of claim 1, wherein the width of the recess is gradual.

3. The linearly-adjustable valve body of claim 1, wherein the mounting hole is in a round table shape, and the end portion of the valve core inserted into the mounting hole is in a round table shape.

4. The linearly-adjustable valve body of claim 1, wherein the number of the air outlet holes is two, and the number of the corresponding first through hole sets and the number of the corresponding recesses are respectively two.

5. The linearly-adjustable valve body of claim 1, wherein the other end of the valve core is connected to a knob.

6. The linearly-adjustable valve body of claim 1, wherein the other end of the valve core is connected to a drive motor.

7. The linearly-adjustable valve body of claim 6, further comprising a self-power generating device which is connected to the drive motor.

8. The linearly-adjustable valve body of claim 7, wherein the self-power generating device is a thermoelectric power generating device.
